(19) United States
(12) Patent Application Publication
(10) Pub. No.: US 2010/0221080 A1
(43) Pub. Date: Sep. 2, 2010

(54) DEVICE FOR GENERATION MACHINING A WORKPIECE CLAMPED IN A MACHINE TOOL AND A METHOD FOR MANUFACTURING A WORKPIECE HAVING A GEARING

(75) Inventors: Josef NEUMAIER, Pfronten (DE); Thomas LOCHBIHLER, Vils (AT); Uwe-Carsten HANSEN, Eisenberg (DE)

Correspondence Address: OLIFF & BERRIDGE, PLC, P.O. BOX 320850, ALEXANDRIA, VA, 22320-4850, US

(73) Assignee: DECKEL MAHO PFRONTEN GMBH, PFRONTEN (DE)

(21) Appl. No.: 12/702,837

(22) Filed: Feb. 9, 2010

(30) Foreign Application Priority Data
Feb. 9, 2009 (DE) 10 2009 008 122.4

(51) Int. Cl. B23F 5/20; B23Q 3/157

(52) U.S. Cl. 409/13; 409/11; 483/30

(57) ABSTRACT

The present invention relates to a device, a method and a machine tool for machining a workpiece clamped in the machine tool, the device comprising a hobbing tool for removing material of the workpiece for shaping a rollable profile, in particular a gearing, on the workpiece by hob milling, and a hobbing tool receiving means for receiving the hobbing tool, the device particularly comprising a milling head fixing means which is suitable to fix the device in a receiving means of the milling head of the machine tool, the machine tool comprising at least 5 axes.

The present invention relates to a device for machining a workpiece clamped in a machine tool comprising a hobbing tool for removing material of the workpiece for shaping a rollable profile, in particular a gearing, on the workpiece by hob milling or hob grinding, and a hobbing tool receiving means for receiving the hobbing tool. Furthermore, the present invention relates to a machine tool, in particular a milling/turning machine tool, a milling/drilling machine tool, a turning/milling machine tool or also a universal machining center equipped with such inventive device.

Furthermore, the present invention relates to a method for manufacturing a workpiece having a rollable profile, in particular e.g. a gearing, by hob milling and/or hob grinding, particularly by a device for machining a workpiece clamped in a machine tool comprising a hobbing tool for removing material of the workpiece for shaping a gearing on the workpiece by hob milling and/or hob grinding, and a hobbing tool receiving means for receiving the hobbing tool.

### BACKGROUND OF THE INVENTION

The prior art discloses the manufacture of gear wheels on special hob milling machines by machining wherein a hob milling tool for removing material of the workpiece for shaping the gearing on the workpiece by hob milling is received in a hob milling tool receiving means for receiving the hob milling tool.

For hob milling the gearing of the workpiece, the hob milling tool is driven such that it rotates about an axis of rotation so that it is suitable to remove material of the workpiece by machining, particularly hob milling, from the workpiece. For this purpose, the prior art discloses that the hob milling tools have a cutting edge shape which makes it possible to shape the gearing of the workpiece by hob milling. In particular, it is disclosed by the prior art to manufacture different shapes of workpieces having rollable profiles, in particular of gear wheels, for example spur gears or bevel gears, having different gearing shapes, in particular spur geared, helical geared, circular arc geared and spiral geared, by the above described hob milling. Particularly, the manufacture of rollable profiles by hob milling requires an exact synchronization of tool movement and workpiece movement in order to be able to manufacture the desired geometry of the rollable profile, in particular of the gearing.

In this process, however, it is a problem in the prior art that such special machine tools for machining a workpiece for shaping a gearing on the workpiece by hob milling by using a hob milling tool in a hob milling tool receiving means can exclusively be used to manufacture the gearing on the workplace.

Consequently, for an optionally required preliminary machining or a remachining of the workpiece, respectively, other, possibly cost-intensive machine tools are necessary in order to be able to perform a rough machining, intermediate machining, remachining or end machining on the workplace. Thus, this requires the purchase of a plurality of cost-intensive machine tools.

In addition, long machining or pass-through times occur in the manufacturing process of a workpiece if the workpiece must be unclamped of a first machine tool and clamped in another, second machine tool during the manufacture on a plurality of machine tools.

### SUMMARY OF THE INVENTION

It is an object of the present invention to provide a device for machining a workpiece clamped in a machine tool for shaping a rollable profile, in particular a gearing, on the workpiece and a corresponding method for manufacturing a workpiece having a rollable profile or a gearing by hob milling or hob grinding wherein the above problems of the methods and devices disclosed by the prior art are avoided.

Furthermore, it is an object of the present invention to provide a device for machining a workpiece clamped in a machine tool and a corresponding method for manufacturing a workpiece having a rollable profile or a gearing by which it is possible to produce a rollable profile or a gearing on a workpiece more flexibly and efficiently and with reduced error, in particular as concerns the desired profile geometry or gearing geometry than in the methods disclosed by the prior art or by the devices disclosed by the prior art.

In order to achieve the above described objects of the present invention, a device for machining a workpiece clamped in a machine tool according to claim 1, a machine tool for machining a workpiece clamped in the machine tool according to claim 10, and a method for manufacturing a workpiece having a gearing according to claim 15 are suggested.

Preferred embodiments and examples are described in the dependent claims.

According to the present invention, a device for machining a workpiece clamped in a machine tool comprises
a hobbing tool for removing material of the workpiece for shaping a rollable profile, in particular a gearing, on the workpiece by generation machining, in particular hob milling or hob grinding, and
a hobbing tool receiving means for receiving the hobbing tool, the device being characterized according to the invention by
a milling head fixing means which is suitable to fix the device on a receiving means of a milling head of the machine tool,
   the machine tool comprising at least 5 axes.

This offers the advantage that the device for machining a workpiece clamped in a machine tool for shaping a rollable profile, in particular a gearing, on the workpiece by generation machining additionally comprises a milling head fixing means apart from a hobbing tool and a hobbing tool receiving means provided for receiving the hobbing tool, which milling head fixing means is suitable to fix the device in a receiving means of a milling head of a machine tool comprising at least 5 axes, in particular to fix and lock it in the tool holding fixture of a milling/turning machine tool, a turning/milling or milling/drilling machine tool comprising at least 5 axes or a universal machining center comprising at least 5 axes, respectively.

Thus, an advantageous device is provided which makes it possible to machine a workpiece in a machine tool comprising at least 5 axes and having a tool holding fixture for milling and drilling tools, wherein it is possible to shape the rollable profile, in particular the gearing, of the workpiece in the machine tool by means of a hobbing tool of the device by generation machining, such as, for example, hob milling or hob grinding. In particular, the device has a fixing means by means of which the device can be received at the tool holding fixture of the machine tool and locked.

This offers the advantage that when a workpiece is machined for shaping a rollable profile, in particular a gearing, on the workpiece by generation machining, in particular by hob milling or hob grinding, a flexible freedom of movement in the control of the milling head of a machine tool comprising at least 5 axes can be used in order to effectively, efficiently and precisely shape many different gearing shapes on the workpiece, especially with reduced error. In particular, it is possible to manufacture partially machined workpieces having partial rollable profiles or a partial gearing and workpieces having a complete gearing, wherein especially even-numbered and odd-numbered gearings can be manufactured. In particular, it is possible to manufacture, for example, bevel and spur gears having different shapes of gearing by generation machining, such as e.g. hob milling or hob gearing, by means of the inventive device on the machine tool comprising at least 5 axes.

The hobbing tool received in the hobbing tool receiving means may e.g. be formed as a hob milling tool, such as, for example, a cylindrical hobbing cutter. Furthermore, the hobbing tool can be formed as a side milling cutter or comprise several side milling cutters. Moreover, the hobbing tool can be formed as a hob grinding tool, for example, as a hob grinding tool comprising one or more profile wheel grinding tools or one or more dish wheel grinding tools which are received in the hobbing tool receiving means, or also as a hob grinding worm, in particular as an enveloping or cylindrical grinding worm received in the hobbing tool receiving means. If one or more side milling cutters or one or more hob grinding tools are used as hobbing tool, the side milling cutters or hob grinding tools may have a profit geometry on one or on both sides according to the tooth flank form to be formed so that the tooth flank form can be formed on one or both sides in one step. Alternatively, the side milling cutters or hob grinding tools may have a geometry or profile different from the geometry or profile of the tooth flank shape, wherein the tooth flank can be formed in a multiple-stage process by controlling the tool along multiple rows at a respective appropriate angle which is only possible because of the high flexibility in movement due to the at least 5 axes.

Here, it is possible in a particularly advantageous manner on a machine tool is comprising at least 5 axes to manufacture the gearing on the workpiece in a centric as well as in an eccentric clamping in the machine tool, the control by the at least 5 axes enabling an exact synchronization between tool movement and workpiece movement for shaping the rollable profile, in particular the gearing exactly according to the specifications, independently of whether the workpiece is clamped centrically or eccentrically. To this end, it is particularly possible to exactly synchronize at least one rotational axis for controlling the tool movement with at least one rotational axis for controlling the workpiece movement and optionally with at least one control of a linear axis. Such synchronization ensures that the movement of the hobbing tool relative to the clamped workpiece is controlled such that the gearing can be formed or shaped exactly in accordance with the specifications. Furthermore, an eccentric clamping of the tool which affects the movement of the workpiece when the rotational axis moving the workpiece is driven can be balanced by corresponding balancing movements and a corresponding synchronization of the other axes during control of the tool even in case of an eccentric clamping of the workpiece so that the movement of the hobbing tool relative to the clamped workpiece is controlled such that the gearing can be formed or shaped exactly corresponding to the specifications. Even an oblique clamping of the workpiece with an workpiece axis that is inclined compared to the rotational axis of a rotary table on which the workpiece is clamped can be balanced due to the high flexibility of the at least 5 axes. It is not necessary to reclamp or correct the clamping. Here, it is possible to optically or mechanically measure the clamping situation by means of sensing elements or by means of a measuring device so that the control of the axes can be adapted in accordance with the actual clamping situation.

Particularly, the at least 5 axes of the machine tool make a movement by five degrees of freedom possible, i.e. preferably at least three translational or linear degrees of freedom and at least two other rotational axes or rotatory degrees of freedom. This offers the advantage that the device comprising the hobbing tool can be moved quickly and precisely into each required position and orientation via the at least three linear and at least two rotatory axes of the machine tool in a tool position and workpiece orientation controllable relative to the workpiece, in particular in case of exact synchronization of the tool control and workpiece control. Thus, due to the five degrees of freedom, it is possible to position or drive the device or hobbing tool to the workpiece relative to the workpiece in five degrees of freedom, in particular in any oblique positions relative to the workpiece. Thus, it is possible to adjust the oblique position of the device relative to the workpiece in an advantageously flexible manner according to a predefined angle for a helical gearing of a spur gear or bevel gear to be manufactured. Furthermore, the oblique positioning of the device relative to the workpiece in the manufacture of a bevel gear can be flexibly adapted to a predetermined bevel angle of the bevel gear. Thus, it is possible due to the flexible positioning in 5 degrees of freedom by means of the at least 5 axes to manufacture bevel gears having any bevel angle. Thus, the machining of a workpiece on a machine tool comprising at least 5 axes for machining a gearing on a workpiece by using the inventive device by generation machining, such as e.g. hob milling or hob grinding, is advantageously more flexible than the machining on a conventional hobbing machine comprising a maximum of three linear axes and merely one rotational axis.

Due to the high flexibility on the basis of the degrees of freedom of the at least 5 axes of the machine tool the device for hob milling or hob grinding and the hobbing tool of the device, respectively, can be moved towards the workpiece clamped in the machine tool in particular at any angle and in any oblique position. Here, it is particularly advantageous according to the present invention that all of the at least 5 axes can be moved simultaneously and synchronized with each other in order to enable a relative movement of the clamped workpiece to the hobbing tool during the generation machining corresponding to a predetermined gearing shaped to be obtained. In this course, synchronized movements of the hobbing tool relative to the clamped workpiece are possible which are not possible on conventional hob milling machine tools due to a smaller number of movable axes. Here, if the workpiece is clamped in the machine tool so as to be rotatably controllable by means of a rotational axis, the rotational axis can be advantageously synchronized with the control of the remaining axes controlling the movement of the device for machining a workpiece. Also the rotational speed of the hobbing tool can be synchronized with the rotational speed of the workpiece.

In particular, due to the degrees of freedom based on the 5-axis control of the machine tool, it is possible to flexibly and exactly manufacture any gearing shapes, for example, including the defining of arcuate or spiral gearings which cannot be manufactured conventionally, i.e. without the degrees of freedom of the 5 axes, or also the defining of gearings having a convexity of the gearing by tilting the device, which is not possible either on conventional machines without the degrees of freedom of the 5 axes.

Preferably, the milling head fixing means is further suitable to fix the device by locking in the receiving means of the milling head of the machine tool.

This offers the advantage that the device can be fixed in the receiving means of the milling head of the machine tool by locking by using the milling head fixing means, wherein the locking of the device in the receiving means can be made preferably analogously to a locking of common devices for receiving a tool in the receiving means of the milling head of the machine tool.

This makes it possible that the device is particularly suitable to be fixed or locked in the receiving means of the milling head in analogy to a common device for receiving a tool. Thus, it is possible to advantageously fix and lock the device for machining a workpiece clamped in a machine tool according to the present invention to a milling head of a common machine tool comprising at least 5 axes, in particular to optionally exchange and lock the device automatically and/or by program-control.

Preferably, the milling head fixing means of the inventive device is further suitable to release the device by unlocking from the fixing in the receiving means of the milling to head of the machine tool if the device is fixed in the receiving means of the milling head of the machine tool.

This makes it possible to release the device from the fixing of the receiving means of the milling head so that the device can be exchanged and replaced, optionally by replacing by a common device for receiving a tool of a machine tool or of a tool itself.

According to the present invention, preferably the device further comprises a gear unit which is preferably suitable to drive the hobbing tool by preferably transferring a rotational movement from a work spindle of the machine tool to the hobbing tool via the gear unit if the device is fixed in the receiving means of the milling head.

This makes it possible to drive the hobbing tool in the hobbing tool receiving means in order to be able to remove material from the workpiece by hob milling. To this end, the gear unit makes it possible to preferably enable the drive by a work spindle of the machine tool by transmitting the rotational movement from the work spindle to the hobbing tool via the gear unit if the device is fixed in the receiving means of the milling head. Furthermore, for this purpose the gear unit may preferably comprise means which are part of the milling head fixing means or at least cooperate with the milling head fixing means so that a transfer of a rotational movement from a work spindle of the machine tool is possible as soon as the milling head fixing means has fixed and/or locked the device in a receiving means of a milling head of the machine tool.

This offers the advantage that a work spindle which is optionally used for driving a tool, in particular a milling or drilling tool, of the machine tool is advantageously also used for driving the hobbing tool of the device for machining a workpiece clamped in the machine tool. Accordingly, it is not necessary to provide another spindle in the machine tool or special means for driving the hobbing tool in the machine tool.

Preferably, the gear unit comprises an angular gear or the gear unit is an angular gear.

This makes it possible to transfer the rotational movement of the work spindle of the machine tool in an especially effective and spatially convenient manner to the hobbing tool because it is possible to provide a device according to the invention in which an axis of rotation of the hobbing tool can be provided essentially orthogonal to a spindle axis or drive axle on the milling head of the machine tool.

As an alternative, in a simple preferred embodiment of the present invention the gear unit may also comprise a counter support including a pin, which provides a rotatory guideway for the hobbing tool, the hobbing tool being rotationally driven by the work spindle via a simple embodiment of a gear unit. This has the advantage that the advantages of the present invention can be provided by a simple construction in combination with a counter support including a pin.

Preferably, the device is further characterized in that the machine tool is a CNC machine tool preferably suitable to move the hobbing tool simultaneously by program-control in preferably 5 degrees of freedom of movement preferably relative to the workpiece clamped in the machine tool if the device is fixed in the receiving means of the milling head of the machine tool.

This has the advantage that the machining of the workpiece can be moved relative to the workpiece in a quick and precise manner, by program-control and particularly simultaneously in the advantageous 5 degrees of freedom of movement, in particular three translational degrees of freedom and two rotational degrees of freedom. Thus, it is particularly possible to execute advantageously complex, program-controlled tool paths by the hobbing tool of the inventive device. Thereby, an exact, program-controlled machining enabling complex geometries on a CNC machine tool comprising at least 5 axes is possible, the machining additionally enabling in a particularly advantageous manner the manufacture of a gearing on the workpiece by hob milling.

Furthermore, such CNC machine tool makes it possible to exchange or replace tools used during the machining of the workpiece in the milling head or in the receiving means of the milling head of the machine tool, preferably by program-control, whereby it is possible, in addition to the manufacture of the gearing of the workpiece by hob to milling or hob grinding using the hobbing tool, to execute further rough machining, intermediate machining, remachining and end machining with other tools, optionally standard tools of the machine tool, preferably automatically or by program-control, in particular in a time-efficient and advantageous manner with low pass-through times.

To this end, preferably the device is particularly suitable to be automatically moved into the receiving means of the milling head for fixing in the receiving means of the milling head, wherein the flexible functionality of a machine tool comprising at least 5 axes may optionally be used, which makes it possible to exchange and/or replace tools or devices for receiving tools in the receiving means of the milling head of the machine tool automatically by program-control.

Preferably, the device according to the invention is further suitable to be kept in a magazine or tool magazine of the machine tool until the device is fixed in the receiving means of the milling head and/or after the device is released from the receiving means of the milling head.

This makes it possible to keep the device during the machining of a workpiece on a machine tool comprising at least 5 axes in a magazine or tool magazine of the machine tool if the machining of the workplace is being carried out by other tools of the machine tool or by using other devices for receiving tools.

Preferably, the hobbing tool receiving means of the device according to the invention is further suitable that a first hobbing tool received in the hobbing tool receiving means can be automatically exchanged with and replaced by a second hobbing tool for replacement, possibly and preferably by program-control.

This offers the advantage that apart from an optionally possible replacement of the inventive device in the receiving means of the milling head, a replacement of the hobbing tool in the hobbing tool receiving means of the inventive device can be made further thereto or instead thereof. This makes it possible to replace a first hobbing tool by a second hobbing tool without replacing the device in the receiving means of the milling head of the machine tool, the first hobbing tool and the second hobbing tool possibly having different cutting edge shapes in order to optionally shape different rollable profile shapes or gearing shapes on the one or possibly on more workpieces.

Furthermore, the present invention provides a machine tool for machining a tool clamped in the machine tool comprising at least 5 axes, the machine tool including at least 5 axes, comprising:
a milling head having a receiving means for receiving tools and/or for receiving tool devices comprising a tool, and
a work spindle for driving a tool received in the receiving means of the milling head, the machine tool according to the invention being particularly characterized in that the machine tool is equipped with a device for machining a workpiece clamped in a machine tool, as described above.

Here, the device according to the invention, which is equipped with the machine tool, preferably corresponds to one of the above described inventive devices having the above described preferred features or to a device having a combination of the above described preferred features.

Preferably, the machine tool according to the invention is further suitable to automatically fix the above described device to the receiving means of the milling head. This makes it possible to automatically fix the inventive device to the receiving means of the milling head, optionally by program-control, and to possibly lock and/or unlock it in order to replace the inventive device by a tool or a device for receiving a tool.

To this end, the machine tool is preferably suitable to automatically replace or able to replace the inventive device by another tool received in the receiving means of the milling head and/or by a tool device comprising a tool and received in the receiving means of the milling head. Preferably, this can be done by program control.

Preferably, the machine tool according to the invention further comprises a magazine or tool magazine which is suitable to receive one or more inventive devices as described above until the device is fixed to the receiving means of the milling head, and/or to receive one or more bobbing tools, for example hob milling tools and/or hob grinding tools.

This has the advantage that a magazine or tool magazine of the machine tool is suitable to optionally receive one or more hob milling tools and/or hob grinding tools, in addition to common tools or standard tools, such as drilling and milling tools, for use on an inventive device and/or inventive devices and to optionally exchange or replace them, preferably by program-control, during the machining of the clamped workpiece.

Preferably, the machine tool according to the invention is further suitable to automatically replace a first hobbing tool that has been received in the hobbing tool receiving means of the inventive device by a second hobbing tool.

This makes it possible to additionally exchange or replace a first hobbing tool by a second hobbing tool on the inventive device, optionally in addition to the possibility of exchanging or replacing an inventive device, the first and the second bobbing tools preferably having respective different cutting edge shapes for manufacturing different gearings on the workpiece. Here, it is also possible to replace, for example, hob milling tools by hob grinding tools.

Finally, the present invention furthermore provides a method for manufacturing a workpiece having a gearing by hob milling, which is particularly characterized in that the workpiece is machined on a machine tool comprising at least 5 axes for shaping the gearing of the workpiece by means of one of the above inventive devices, possibly by a device having one of the above-mentioned preferred features or a combination of a plurality of the above described preferred features.

### BRIEF DESCRIPTION OF THE FIGURES

FIG. 1 shows a machine tool according to an embodiment of the present invention.

FIG. 2 shows an embodiment of a device, in particular of a hob milling device, according to an embodiment of the present invention.

### DETAILED DESCRIPTION OF THE FIGURES AND PREFERRED EMBODIMENTS OF THE INVENTION

In the following, the present invention will be described and explained in detail by referring to an embodiment of a machine tool according to the present invention, in particular equipped with an embodiment of the inventive device according to the present invention for machining a workpiece clamped in a machine tool by means of exemplary figures. In this process, the manufacture of workpieces having a gearing will particularly be described in detail. However, it should be noted that the present invention is not limited to the shaping of gearings on workpieces but rather can also shape any rollable profiles on workpieces by using a suitable hob milling tool or hob grinding tool or a hob milling tool or hob grinding geometry having suitable cutting edge geometry or profile geometry. Here, rollable profiles even comprise profile shapes which cannot be rolled on hob milling machines disclosed by the prior art but can only be made possible or rolled due to the flexible freedom of movement on a machine tool comprising at least 5 axes.

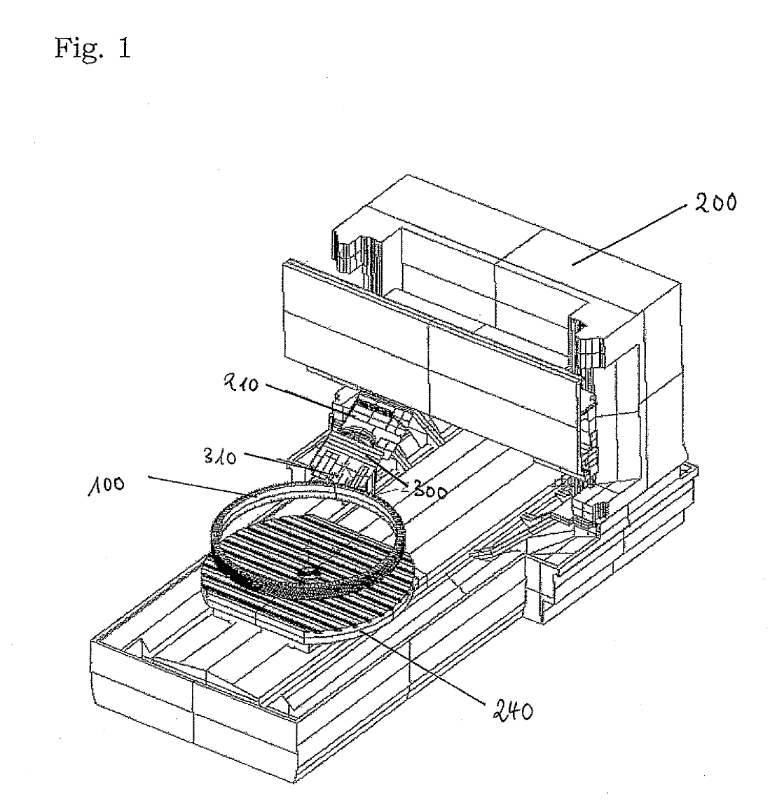

FIG. 1 shows a machine tool 200 comprising a milling head 210 and a rotary table 230 which includes means (not shown) for clamping a workpiece 100 on the rotary table 240. Furthermore, FIG. 1 shows an embodiment of the inventive device 300 for machining a workpiece 100 clamped in a machine tool 200 by using a hob milling tool 310 for removing material of the workpiece 100 for shaping a gearing on the workpiece by hob milling.

In this embodiment the illustrated machine tool 200 is a CNC-controlled machine tool comprising 5 axes, in particular 3 linear axes for moving the milling head relative to the clamped workpiece and 2 rotatory axes. However, the present invention is not limited to 5-axis machine tools but rather may furthermore be adopted for machine tools that can simultaneously drive more than 5 axes by program-control, for example, at least 3 translatory linear axes and at least 3 rotatory rotational axes.

Here, the at least 5 axes of the machine tool enable a tool guideway or hob milling tool guideway in which the tool or hob milling tool can be moved in 5 degrees of freedom of movement, comprising the 3 translatory degrees of freedom and 2 angular degrees of freedom, in particular rotational degrees of freedom, enabling a free orientation of the tool axis.

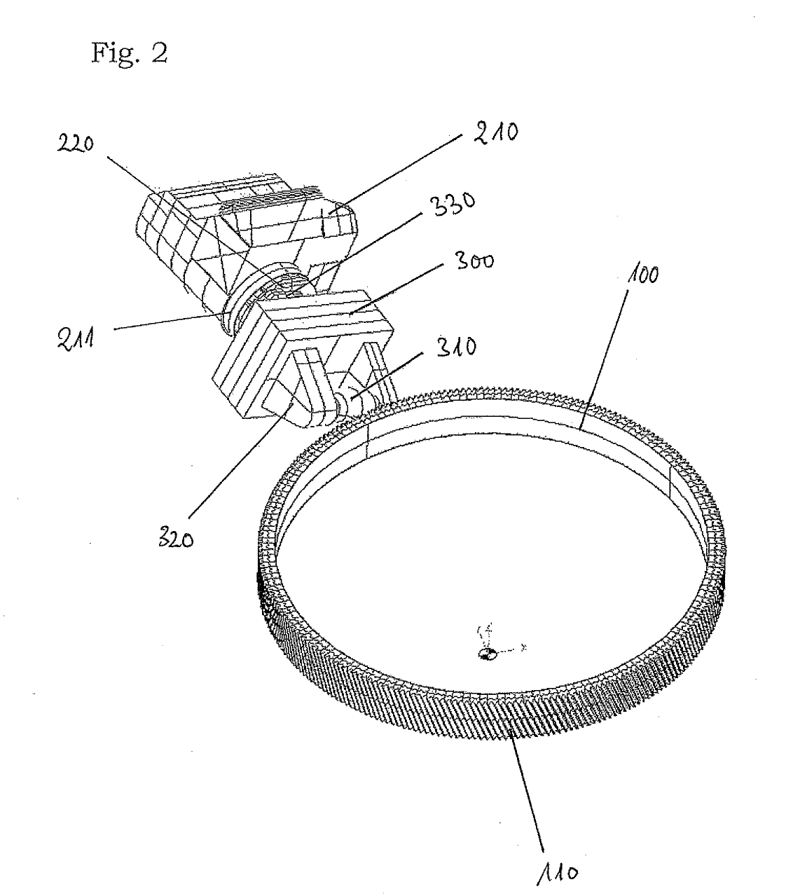

The milling head 210 of the machine tool 200 of FIG. 1 is shown together with the device 300 in FIG. 2 in magnification. FIG. 2 shows the milling head 210 and the receiving means 211 integrated in the milling head 210, which is suitable to receive tool receiving devices, in particular milling tool receiving devices, and the inventive device 300. Furthermore, FIG. 2 shows an embodiment of the inventive device 300, referred to below as the hob milling device 300 which comprises a hob milling tool receiving means 320 for receiving the hob milling tool 310.

Furthermore, FIG. 2 shows an exemplary finished part of a workpiece 100 having a gearing 110, here an exemplary spur gear having helical gearing, the positioning of the hob milling device 300 being illustrated with which a machining of the workpiece 100 is made possible by guiding the milling head 210 in order to manufacture the shown gearing 110. FIG. 2 does not show a clamping means of the machine tool 200 for clamping the workpiece 100, in particular a rotary table 240, the clamping making it optionally possible to move the workpiece 100 about a rotatory axis.

In summary, the 5 degrees of freedom of the machine tool make it possible to move the hob milling device 300 including the hob milling tool 310 in any orientation and path movement relative to the clamped workpiece 100 in order to be able to manufacture the gearing 110 on all sides of the workpiece 100.

A gear unit integrated in the housing of the hob milling device 300, which makes it possible to transfer a rotational movement of a work spindle, not shown, of the machine tool 200 from the work spindle 220 to the hob milling tool 310 when the hob milling device 300 is fixed in the receiving means 211 of the milling head 210 in order to be able to drive the hob milling tool 310 for removing material from the workpiece 100 by hobbing, is not shown.

In this embodiment of the device an axis of rotation of a transfer means of the gear unit is orthogonal to the axis of rotation of the hob milling tool so that the gear unit in this embodiment is an angular gear.

However, the present invention is not limited to angular gears but can be provided by different embodiments of a gear unit which are suitable to transfer a rotational movement of a work spindle 220 of the machine tool 200 to the hob milling tool 310 when the hob milling device 300 is fixed. In addition, it is possible to control the rotational speed of the hob milling tool 310, optionally by program-control, in particular optionally by other transmission means.

Particularly, it is possible to provide the advantages of the present invention in another embodiment of the present invention by means of a hob milling device having a structure comprising a counter support including a pin, the pin fixing a hob milling tool and enabling a rotation about a tool axis of the hob milling tool. In this case, the device comprises a gear unit which makes it possible to rotationally drive the hobbing tool by the work spindle or another spindle. Furthermore, the device can be fixed to a receiving means of a machine tool by a milling head fixing means.

Such receiving means, in particular the receiving means 211 of the milling head 210 shown in FIG. 2, is suitable to fix the hob milling device 300 and a milling head fixing means 330 of the hob milling device, respectively, in the receiving means 211 on the milling head 210 by locking. Accordingly, the receiving means 211 and accordingly the milling head fixing means 330 as well is suitable to release the fixing of the hob milling device 300 on the milling head 210 by unlocking.

Furthermore, the machine tool 200 in this embodiment of the present invention comprises a magazine (not shown) comprising a plurality of milling and drilling tools of the machine tool, the magazine further comprising tool devices suitable to receive a milling or drilling tool. The magazine is suitable to furthermore store a hob milling device 300 or optionally a plurality of hob milling devices 300 if these are not needed for machining the workpiece 100.

In this embodiment of the present invention the control of the machine tool comprising at least 5 axes is made via CNC control data which control a movement of a tool, in particular the hob milling tool 310, by program-control along predetermined paths by using the CNC control data, the tool paths enabling a free movement in 5 degrees of freedom relative to the workpiece 100. Thus, the CNC control data control the program-controlled machining of the finished part 100 by optionally simultaneously driving all or some axes of the machine tool 200.

In this process, the machine tool 200 is suitable to execute CNC control data which give instructions that a tool or a device receiving a tool is replaced for machining the workpiece 100 during the machining in order to execute further working steps during the machining of the workpiece 100. Thus, it is particularly possible to machine a workpiece 100 on the machine tool 200, wherein at least one of the working steps enables the manufacture of a gearing 110 on the workpiece 100 by hob milling by automatically receiving, inserting and/or locking an inventive hob milling device 300 having a hob milling tool 310 in the receiving means 211 of the milling head 210 via a milling head fixing means 300.

Furthermore, the machine tool 200 makes it possible to replace the milling device 300 by a tool device for receiving a tool, in particular a milling or drilling tool, in order to travel another machining path for machining the workpiece 100.

Moreover, the hob milling device 300 according to this embodiment of the present invention makes it possible to replace a first hob milling tool 310 by a second hob milling tool or also a hob grinding tool, the second hob milling tool optionally having a different cutting edge shape for manufacturing a different gearing shape 110 on the workpiece 100, wherein the replacement of the hob milling tool 310 by a second hob milling tool can be made in this case without replacing the hobbing device 300 on the milling head 210.

In summary, the present invention provides a machine tool 200, a hob milling device 300 and a method for machining a workpiece 100 having a gearing 110 on a machine tool 200 comprising at least 5 axes, which makes it possible to manufacture workpieces 100 having a gearing, in particular gear wheels, for example spur gears or bevel gears having gearings of any kind, in particular spur gearing, helical gearing, circular arc gearing, involute gearing, spiral gearing etc., efficiently and precisely and optionally by program-control on a machine tool 200 comprising at least 5 axes. Furthermore, any rollable profiles are possible. Thus, it is particularly possible to define gearing shapes which cannot be manufactured on conventional hob milling machines comprising a maximum of three linear axes and one rotational axis.

In a particularly advantageous manner, this makes it possible to use, for example, a standard 5-axis universal milling and drilling machine or another machine tool comprising at least 5 axes for manufacturing a workpiece having a rollable profile, in particular a gearing, without the requirement of further expensive special machines, for example, special hob milling machines. Here, the hob milling device according to the invention can be automatically exchanged and replaced by program-control and/or automatically locked in analogy to e.g. an attachment spindle.

According to the invention, the drive of the rotating hob milling tool 310 for removing material from the workpiece 100 for shaping the gearing 110 is performed by means of a gear unit driven by the work spindle via an angular gear optionally integrated in the housing of the hob milling device 300.

Hereby, a device for machining a workpiece 100 clamped in a machine tool 200 for shaping a gearing 110 on the workpiece 100 by hob milling is provided, wherein the device 300 including the hob milling tool 310 on the machine tool comprising at least 5 axes can be moved to any necessary, desired position and/or orientation relative to the workpiece, in particular a gear wheel such as a spur gear or a bevel gear, via at least 3 linear and at least 2 rotatory axes of the machine tool.

1. A device for machining a workpiece clamped in a machine tool, comprising:
a hobbing tool for removing material of the workpiece for shaping a rollable profile, in particular a gearing on the workpiece by hob milling, and
a hobbing tool receiving means for receiving the hobbing tool,
wherein
a milling head fixing means which is suitable to fix the device in a receiving means of a milling head of the machine tool,
the machine tool comprising at least 5 axes.

2. The device according to claim 1, wherein the milling head fixing means is suitable to fix the device by locking in the receiving means of the milling head of the machine tool.

3. The device according to claim 2, wherein the milling head fixing means is suitable to release the device by unlocking from the fixing in the receiving means of the milling head of the machine tool.

4. The device according to claim 1, wherein
a gear unit which is suitable to drive the hobbing tool by transferring a rotational movement from a work spindle of the machine tool to the hobbing tool via the gear unit if the device is fixed in the receiving means of the milling head.

5. The device according to claim 4, wherein the gear unit comprises an angular gear and/or a counter support including a pin.

6. The device according to claim 1, wherein the machine tool is a CNC machine tool which is suitable to move the hobbing tool simultaneously by program-control in 5 degrees of freedom of movement relative to the workpiece clamped in the machine tool if the device is fixed in the receiving means of the milling head of the machine tool.

7. The device according to claim 1 the device is suitable to be automatically moved into the receiving means of the milling head for fixing in the receiving means of the milling head.

8. The device according to claim 7, wherein the device is suitable to be kept in a magazine of the machine tool until the device is fixed in the receiving means of the milling head.

9. The device according to claim 1, wherein the hobbing tool receiving means is suitable that a first hobbing tool received in the hobbing tool receiving means can be automatically exchanged with and replaced by a second hobbing tool for replacement.

10. A machine tool for machining a workpiece clamped in the machine tool, the machine tool comprising at least 5 axes, comprising:
a milling head having a receiving means for receiving tools and/or for receiving tool devices comprising a tool, and
a work spindle for driving a tool received in the receiving means of the milling head,
wherein
the machine tool is equipped with a device according to claim 1.

11. The machine tool according to claim 10, which is suitable to automatically fix the device to the receiving means of the milling head.

12. The machine tool according to claim 11, which is suitable to automatically exchange the device with another tool received in the receiving means of the milling head and/or which is suitable to automatically replace the device by a tool device comprising a tool and received in the receiving means of the milling head.

13. The machine tool according to claim 10 the machine tool comprises a magazine which is suitable to receive the device until the device is fixed to the receiving means of the milling head and/or to receive one or a plurality of bobbing tools.

14. The machine tool according to claim 1, wherein the machine tool is suitable to automatically replace a first hobbing tool that has been received in the hobbing tool receiving means by a second hobbing tool.

15. A method for manufacturing a workpiece having a gearing by hob milling, wherein the workpiece is machined on a machine tool comprising at least 5 axes according to claim 10 for shaping the rollable profile, in particular the gearing, of the workpiece by means of the device.
